(19) United States
(12) Patent Application Publication
(10) Pub. No.: US 2016/0340594 A1
(43) Pub. Date: Nov. 24, 2016

(54) SYSTEMS FOR ETHANOL TO FUELS IN A CATALYTIC CRACKING UNIT STRIPPER

(71) Applicant: PHILLIPS 66 COMPANY, Houston, TX (US)

(72) Inventors: William D. HENNING, Bartlesville, OK (US); Walter E. ALVAREZ, Bartlesville, OK (US); Jianhua YAO, Bartlesville, OK (US)

(73) Assignee: PHILLIPS 66 COMPANY, Houston, TX (US)

(21) Appl. No.: 14/955,961

(22) Filed: Dec. 1, 2015

Related U.S. Application Data
(60) Provisional application No. 62/089,310, filed on Dec. 9, 2014.
(60) Provisional application No. 62/089,314, filed on Dec. 9, 2014.

(51) Int. Cl. C10G 3/00; B01J 8/00; C10G 11/18; B01J 8/24

(52) U.S. Cl. CPC C10G 3/42; B01J 8/24; B01J 8/005; C10G 11/18; B01J 2208/00823; B01J 2208/00893; B01J 2208/00256; C10G 2300/202

(57) ABSTRACT

Systems relating to the conversion of ethanol in a stripper unit of a fluidized catalytic cracking system. An ethanol stream mixes with a catalyst in the stripper unit under conditions of temperature that favor conversion of the ethanol to hydrocarbons, thereby increasing incorporation of ethanol into liquid transportation fuels without exceeding regulatory limits on fuel vapor pressure. Certain embodiments combine the ethanol stream with a hydrocarbon stream and react in the presence of a catalyst in the stripper to produce hydrocarbons that may have an increased boiling point, increased octane rating, decreased vapor pressure, decreased benzene content, or combinations thereof.

### STATEMENT REGARDING FEDERALLY SPONSORED RESEARCH OR DEVELOPMENT

This application is a non-provisional application that claims the benefit of and priority to U.S. Provisional Application Ser. No. 62/089,310 filed Dec. 9, 2014, titled “Systems for Ethanol to Fuels in a Catalytic Cracking Unit Stripper” and U.S. Provisional Application Ser. No 62/089,314 titled “Ethanol to Fuels in a Catalytic Cracking Unit Stripper”. Both applications are incorporated by reference in their entirety.

### FIELD OF THE INVENTION

The present invention relates to systems that co-convert ethanol to liquid hydrocarbons fuels.

### BACKGROUND OF THE INVENTION

Due to recently-enacted US Environmental Protection Agency regulations (Mobile Sources Air Toxics Phase 2), all US reformulated gasoline (RFG) is restricted to a benzene level of 0.62 percent (by volume) as of Jan. 1, 2011. Also, US refiners are now limited to a maximum average benzene content of 1.3% (by vol.) in all products.

The new regulations require refiners to find additional strategies to reduce address benzene levels. It is necessary to examine solutions in the context of the entire refinery while taking into account new regulations on volatile organic compounds (VOCs) and ethanol blending.

FCC naphtha is thought to contribute 10-15% of the total benzene present in the gasoline pool. Thus, new processes and systems can assist in decrease the overall content of benzene in the products of FCC operation may potentially improve the environment and decrease health risks associated with exposure to this chemical.

Meanwhile, US government mandates have required increasing quantities of biomass-derived ethanol to be blended into transportation fuels. Due to concurrent reductions in US gasoline production and consumption, the quantity of ethanol blended into gasoline may soon exceed 10%, which may have implications for the operability of certain older vehicles not designed to utilize such fuels. Additionally, blending of increasing quantities of biomass-derived ethanol into fuels can increase the overall Reid vapor pressure to levels that exceed government mandated levels. Accordingly, a need also exists for new methods and systems that allow increased incorporation of biomass-derived ethanol into liquid transportation fuels, while preserving the suitability of the resulting fuel for use in most vehicles and maintaining an acceptable Reid vapor pressure of the fuel.

### BRIEF SUMMARY OF THE DISCLOSURE

Certain embodiments comprise a system for converting ethanol to liquid transportation fuels, that includes a catalyst; an ethanol stream and a fluidized catalytic cracking unit that in turn comprises: 1) a riser comprising a reaction zone and adapted for mixing the catalyst with a petroleum-derived feedstock and further adapted for cracking the petroleum derived feedstock to cracked hydrocarbon vapors; 2) a reactor main body adapted for separating cracked hydrocarbon vapors and the catalyst; 3) a stripper unit that is operable at a temperature between about 260° C. and about 550° C. and comprises at least a first inlet that receives the catalyst, and at least a second inlet that receives the ethanol stream. The arrangement of the at least one first inlet and the at least one second inlet operates to facilitate rapid mixing of the catalyst with the ethanol stream, and operates to convert the water to steam. The stripper unit operates to facilitate mixing of the catalyst with the steam, which strips hydrocarbons from the catalyst. The stripper unit is also operates to receive and facilitate contact of the ethanol stream with the catalyst. This results in conversion of at least a portion of the ethanol stream to a mixed product stream comprising hydrocarbons.

In certain embodiments of the system, the steam is at least partly-derived from the water in the ethanol stream. In certain embodiments, the arrangement of the at least one first inlet and the at least one second inlet of the stripper unit operate to convert the water to steam prior to contacting the catalyst. In certain embodiments, the system also includes a first outlet that operates to discharge a mixed product stream comprising hydrocarbons and stripped catalyst to the main body of the reactor.

In certain embodiments, the system also includes a heater that operates to heat the ethanol stream that is connected to allow the ethanol stream to be conveyed to the stripper unit. The heater heats the ethanol stream to a temperature that vaporizes the ethanol stream upon entry to the stripper unit and prevents condensation of the water in the stripper unit. IN certain embodiments the heater also is a mixer that operates to receive and mix the ethanol stream with a stream of hot steam.

In certain embodiments of the system, the stripper unit includes at least two inlets that operate to receive catalyst, where at least a first inlet is configured to receive spent catalyst and at least a second inlet is configured to receive fresh catalyst. In these embodiments, the stripper unit is configured to contact the fresh catalyst with the spent catalyst and the ethanol stream.

In certain embodiments of the system, the ethanol stream is derived from biomass and comprises at least 4 weight percent, at least 20 weight percent, or even at least 40 weight percent water.

In certain embodiments of the system, the stripper unit additionally includes a third inlet for a stream of cracked hydrocarbons transported from a location near the upper portion of the riser, where the arrangement of the first, second and third inlets facilitates mixing of the catalyst, the ethanol stream and the stream of cracked hydrocarbons.

In certain embodiments of the system, the stripper unit additionally includes a third inlet that operates to receive a stream of hydrocarbons transported from a fractionator located immediately downstream from the reactor of the fluidized catalytic cracking unit. In these embodiments, the arrangement of the first, second and third inlets facilitates mixing of the catalyst, the ethanol stream and the stream of cracked hydrocarbons.

### BRIEF DESCRIPTION OF THE DRAWINGS

A more complete understanding of the present invention and benefits thereof may be acquired by referring to the follow description taken in conjunction with the accompanying drawings in which:

FIG. 1 is a schematic diagram depicting components and a process for converting ethanol to liquid fuels in a stripper unit of a fluidized catalytic cracking unit (FCCU).

FIG. 2 is a schematic diagram depicting components and a process for co-converting a mixture of ethanol and catalytically-cracked hydrocarbons to liquid fuels in a stripper unit of an FCCU.

The invention is susceptible to various modifications and alternative forms, specific embodiments thereof are shown by way of example in the drawings. The drawings may not be to scale. It should be understood that the drawings and their accompanying detailed descriptions are not intended to limit the scope of the invention to the particular form disclosed, but rather, the intention is to cover all modifications, equivalents and alternatives falling within the spirit and scope of the present invention as defined by the appended claims.

### DETAILED DESCRIPTION

Various exemplary embodiments of the inventive processes and systems will now be described in more detail. Certain embodiments pertain to the conversion of biomass-derived ethanol to transportation fuels in a stripper unit of a FCCU. Certain embodiments additionally relate to co-converting in a stripper unit a mixture of biomass-derived ethanol and cracked hydrocarbons that were produced in an FCC riser. The inventive processes and systems effectively allow incorporation of greater quantities of biomass-derived ethanol into liquid transportation fuels without raising the final ethanol content of the finished fuel above about 10 weight percent, and without increasing the Reid vapor pressure of the finished fuel to levels deemed unacceptable by government regulations.

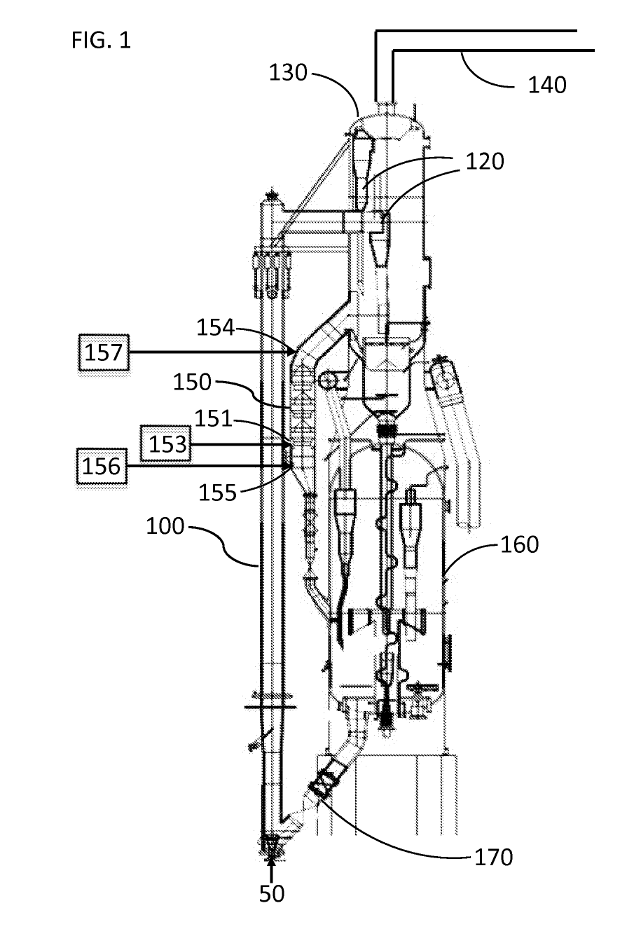

FIG. 1 details components of an exemplary process and system. The general operation of an FCCU is well-understood in the art and will only be described herein to a level of detail that helps illustrate the improvements provided by the inventive systems and processes described herein.

Fluidized Catalytic Cracking (FCC) is characterized by the use of a finely-divided silica/alumina based catalyst that is moved through the FCCU. A commercial-scale FCCU is a large-scale process and unit throughputs are typically in the range of about 10,000 to 130,000 barrels per day, which corresponds to catalyst circulation rates of 7 to 130 tons per minute.

The catalyst particles typically utilized are of such a size that when “fluidized” with air or hydrocarbon vapor, the catalyst behaves like a liquid and can be transported through pipes. Referring to FIG. 1, a petroleum-derived feedstock 50 and catalyst released in a controlled manner from a standpipe 170 flow together into a riser 100 comprising a reaction zone where a majority of initial cracking reactions take place. The petroleum-derived feedstock 50 and the catalyst mix together and rise through the riser as the feedstock is vaporized and cracked. Cracked vapors and the catalyst (which is now spent) leave the top of the riser 100 are then separated as they pass through cyclones 120 located just downstream from the riser 100 in the reactor (or separation vessel) 130, which separates spent catalyst from the cracked vapors by centrifugal force. The cracked vapors pass out of the reactor 130 via an outlet 140 and enter one or more fractionating towers (not depicted), which fractionate the cracked vapors into light and heavy-cracked gas oils, cracked gasoline, C₃-C₄ products (sometimes called liquefied petroleum gasses, or LPG), and non-condensable gases including, but not limited to, H₂, H₂S, methane, and C₂ gases.

The activity of the catalyst is decreased by coking that occurs while in the riser 100. Spent catalyst is coated with hydrocarbons that are preferably removed and collected prior to catalyst regeneration. Spent catalyst is separated from cracked vapors in the cyclones 120 of the reactor 130, then the spent catalyst flows by gravitational force into the upper portion of a stripper unit 150 that may be either integral to, or distinct from, the reactor 130. In general, a stripper unit defines a space that is dedicated to removing residual hydrocarbons adhering to the surface of the spent catalyst prior to feeding the spent catalyst to a regenerator. The stripper unit 150 additionally comprises at least one inlet 151 for steam 153, which moves upward through the stripper unit 150 in counter-current flow to the descending spent catalyst. The steam acts to remove, or strip, at least a portion of heavy hydrocarbons still adhering to the spent catalyst. The hydrocarbons stripped off the catalyst are returned to the reactor 130 and eventually recovered as products in a downstream fractionator (not depicted).

The stripper unit includes at least one inlet 155 located proximate the bottom portion of the stripper unit for feeding of an ethanol stream 156 into the stripper unit 150. The ethanol stream 156 may be derived from any source, but is preferably derived from biomass, in which case it may be produced from biomass via any known mechanism (such as, but not limited to, fermentation). Such production methods are conventional and outside the scope of the invention. In certain embodiments, the ethanol stream is a raw ethanol stream that is derived from biomass and includes some amount of water. In these embodiments, the raw ethanol stream comprises at least 4 volume percent of water.

Again referring to FIG. 1, in certain embodiments the stripper unit 150 additionally comprises at least one inlet 154 for the entry of fresh catalyst 157. The fresh catalyst can serve to replenish old catalyst in the FCCU, facilitate chemical reactions within the stripper unit, or combinations thereof. In certain embodiments, the fresh catalyst 157 is added to the stripper unit at a temperature that assists in altering the temperature of the stripper unit. For example, in one embodiment, the temperature of the fresh catalyst is lower than the temperature within the stripper unit, which causes quenching, or lowering of the temperature within the stripper unit. Quenching the stripper to a lower temperature may assist in optimizing the temperature to facilitate certain chemical reactions within the stripper unit.

The catalyst within the stripper unit 150 may comprise spent catalyst or a mixture of spent and fresh catalyst, and converts ethanol in the ethanol stream to a mixed product stream that predominantly comprises hydrocarbons containing 4-15 carbon atoms. The mixed product stream is then conveyed from the stripper unit 150 to the reactor (or separation unit) 130 where it is separated from catalyst by cyclones or other conventional mechanisms that are outside the scope of the invention. The mixed product stream is maintained in vapor phase and directed to a downstream fractionator (not depicted) where it is separated into various liquid fractions by boiling point. Such fractionation methods are conventional and are outside the scope of the invention, and will not be discussed further. Various liquid hydrocarbon fractions derived from the fractionator that comprise from 4-15 carbon atoms, inclusive, are typically used as blend stock to produce liquid transportation fuels, including gasoline, jet and diesel fuels.

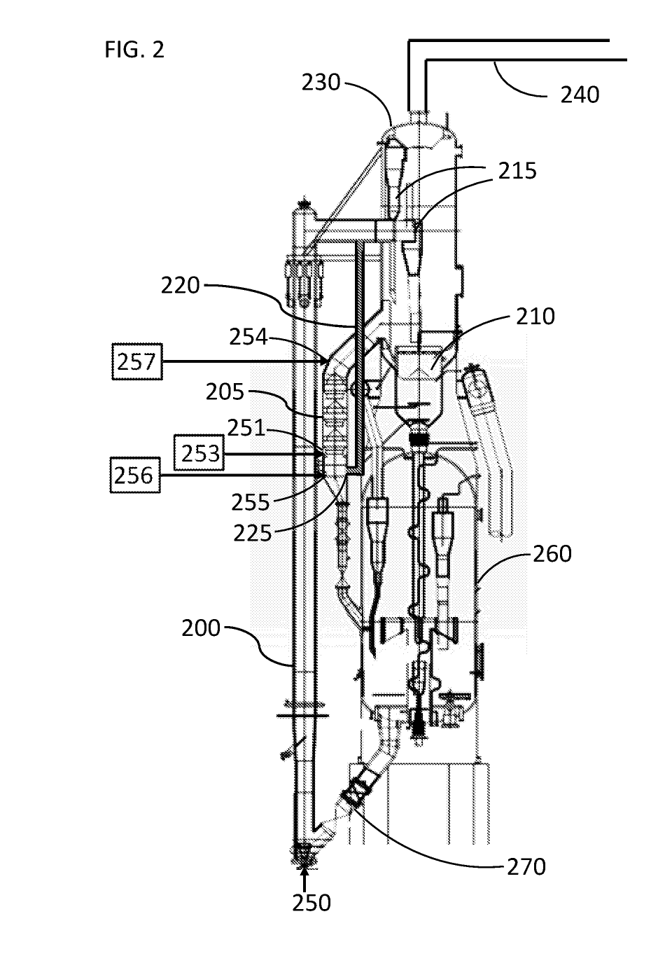

Certain embodiments utilize more than one stripper unit. FIG. 2 depicts an embodiment wherein a first stripper unit 210 is integral with the reactor 230, while a second stripper unit 205 is external to the reactor 230. In embodiments that utilize more than one stripper unit, one or more stripper units may additionally receive a stream of hydrocarbons fed to the stripper unit in relative close proximity to the inlet 255 for the ethanol stream 256. In the embodiment depicted in FIG. 2, the second stripper unit 205 receives a cracked hydrocarbon stream in a conduit 220 directed from the upper portion of FCC riser 200. Cracked hydrocarbon stream enters the second stripper unit 205 via an inlet 225, mixes and reacts with the ethanol in the ethanol stream 256, which enters the second stripper unit via a nearby inlet 255.

The embodiment in depicted FIG. 2 allows entry of fresh catalyst 257 via an inlet 254 that is proximate the upper portion of the second stripper unit 205. The fresh catalyst can serve to replenish old catalyst in the FCCU, facilitate chemical reactions within the stripper unit, or combinations thereof. Once this fresh catalyst exits the second stripper unit 205, it is conveyed to a regenerator 260 where it mixes with catalyst that was stripped in the first stripper unit 210 before being stored in standpipe 270 prior to being injected into riser 200 along with a petroleum-derived feedstock 250.

Again referring to the embodiment depicted in FIG. 2, cracked vapors and the catalyst (which is now spent) leave the top of the riser 200 are then separated as they pass through cyclones 220 located just downstream from the riser 200 in the reactor (or separation vessel) 230, which separates spent catalyst from the cracked vapors by centrifugal force. The cracked vapors pass out of the reactor 230 via an outlet 240 and enter one or more fractionating towers (not depicted), which fractionate the cracked vapors into light and heavy-cracked gas oils, cracked gasoline, C₃-C₄ products (sometimes called liquefied petroleum gasses, or LPG), and non-condensable gases including, but not limited to, H₂, H₂S, methane, and C₂ gases

In certain alternative embodiments, the stream of hydrocarbons that is fed to the second stripper may be a fraction re-directed from the downstream fractionator that separates the mixed product stream (and cracked hydrocarbons produced by the FCCU) into various fractions according to their boiling point. This fraction advantageously comprises aromatics that are at least partially converted in the stripper unit to hydrocarbons that may possess an increased molecular weight, an increased boiling point, a decreased Reid vapor pressure, an increased octane rating, or combinations of more than one of these attributes.

While not wishing to be bound by theory, embodiments that mix a hydrocarbon stream and an ethanol stream together with a catalyst in a stripper unit may provide an advantage by facilitating increased chemical reactions between the cracked hydrocarbons and the ethanol in the ethanol stream. In certain embodiments, this may serve to facilitate the conversion of benzene in the cracked hydrocarbons to alkylaromatics, thereby decreasing the quantity of benzene in the mixed product stream. In certain embodiments, this may facilitate an increase the octane rating of the mixed product stream comprising hydrocarbons, or decrease the Reid vapor pressure of the mixed product stream.

In embodiments comprising multiple stripper units, each stripper unit is optionally maintained in a different temperature range that is optimized to favor certain chemical reactions, such as (but not limited to) oligomerization, condensation and alkylation. For example, a stripper unit receiving only a feed of ethanol stream may be temperature-optimized for the catalyzed conversion of ethanol to C4-C15 hydrocarbons. Alternatively, a stripper unit may optionally be maintained within a temperature range to favor the alkylation of aromatics by ethanol. Alternatively a stripper unit may be maintained within a temperature range to favor the reaction between olefins and ethanol to form C4-C15 hydrocarbons.

To accomplish these goals, each stripper unit may be maintained at a temperature ranging from 260° C. (500° F.) to 550° C. (1022° F.), optionally 315° C. (600° F.) to 510° C. (950° F.), optionally 650° F. to 950° F., optionally 550 ° F. to 800 ° F. 700° F. to 950° F., optionally 750° F. to 900° F., optionally 700° F. to 850° F., optionally 700° F. to 900° F., optionally 800° F. to 900° F., optionally 700° F. to 800° F. and a pressure ranging from about 1 to 145 psig (0.07 to 10 bar).

Quenching the second stripper unit to a lower temperature may assist in optimizing the temperature to facilitate certain chemical reactions within the stripper unit. In certain embodiments, fresh catalyst is added to the stripper unit at a temperature that assists in altering the temperature of the stripper unit. For example, in one embodiment, the temperature of the fresh catalyst is lower than the temperature within the stripper unit, which causes quenching, or lowering of the temperature within the stripper unit. In certain embodiments, quenching may be achieved by injecting steam at a lower temperature, increasing the water content of the ethanol stream, decreasing the temperature of the ethanol stream that is fed to the second stripper.

Referring again to FIG. 1, once the spent catalyst has been steam-stripped to remove hydrocarbons in the stripper unit 150, it eventually is moved to a regenerator 160, where coke is removed from the catalyst by controlled combustion in a conventional manner that is outside the scope of the invention. Regenerated catalyst is stored in a standpipe 170, then released in a controlled manner to an inlet near the bottom portion of the riser 100 in close proximity to the inlet for the petroleum-derived FCC feedstock 50. This allows the regenerated catalyst to assist in vaporizing the fresh petroleum-derived FCC feedstock 50 just prior to cracking of the feedstock in the riser 100.

Optionally, the ethanol stream may comprise from 4 to 95 volume percent water, inclusive, or may comprise at least 5, 10, 15, 20, 30, 40, 50, 60, 70 or even at least 80 weight percent of water. In certain embodiments, the ethanol stream may comprise up to 5, 10, 15, 20, 30, 40, 50, 60, 70, 80, or even as much as 95 weight percent water, inclusive, without adversely affecting conversion of the ethanol stream to hydrocarbons by the catalyst (depending upon the sensitivity of the catalyst utilized to deactivation by water vapor). In certain embodiments, the wt. % of water in the ethanol stream may find an upper limit, although this upper limit may vary significantly depending upon the catalyst utilized and the conditions of temperature and pressure in each stripper unit.

In general, the temperature within each stripper unit must be sufficient to prevent condensation of any water that is present, including water that is fed to the stripper unit as a component of the ethanol stream. This prevents damage to the catalyst within the stripper unit, particularly if the catalyst comprises one or more metals. Alternatively, a certain quantity of water may be removed from the ethanol stream to produce a partially-processed ethanol stream prior to entering the stripper unit. Techniques for achieving this separation may include distillation, pervaporation (such as in the presence of a zeolite membrane) or any other conventional separation methodology.

The catalyst used in the conversion unit for any embodiment may comprise any catalyst that is capable of facilitating the cracking of large hydrocarbons into smaller hydrocarbons at a suitable temperature, while additionally capable of catalyzing the conversion of ethanol to produce larger hydrocarbons comprising four or more hydrocarbons and the co-conversion of ethanol with aromatics, olefins, or both. The catalyst is preferably resistant to the presence of water.

In certain embodiments, the catalyst may comprise any type of zeolite that is capable of catalyzing reactions between hydrocarbons to produce a higher molecular weight hydrocarbon. Such zeolites may be, but are not limited to, zeolites of one or more of the following categories: Y, X, MFI, FAU, beta, HY, EMT, USY, MOR, LTL BEA, MCM, ZSM, REY, REUSY and SAPO. The catalyst may also be impregnated with a metal, such as, for example, a rare earth metal, alkali metal, or alkaline earth metal. In certain embodiments, the aluminum of the zeolite structure can be totally or partially substituted by poor metals such as, for example, B, Ga, or Fe. An extensive characterization of such catalysts and structural or substituted variants is well known in the art.

The following examples are provided to better illustrate one or more of the various embodiments.

### EXAMPLE 1

Table 1 shows the selectivity of the conversion reaction towards production of hydrocarbons. A feed mixture comprising ethanol was fed at 2 g/hr (per 5 g catalyst) in the presence of a gaseous mix of H₂/N₂/H₂O (ratio of 36/23/8 by volume). A zeolite catalyst ZSM-5 was contacted with the mixture at a temperature of 320° C. and 50 psig. The results (depicted in Table 1) demonstrated that production of hydrocarbons comprising five or more carbons (C5+) was highly-favored.

TABLE 1
Product Selectivity from the Conversion
of Ethanol to Hydrocarbons

| | |
|---|---|
| Ethanol Conversion (wt. %) | ~100 |
| Product Selectivity (wt. %) | |
| Methane | 0.0 |
| Ethane | 0.5 |
| Propane | 3.7 |
| Propylene | 1.3 |
| Butanes | 14.3 |
| Butenes | 2.9 |
| C5+ | 77.2 |
| Total, (wt. %) | ~100.0 |

### EXAMPLE 2

Table 2 provides an example of co-conversion between ethanol and the olefin ethylene, demonstrating the feasibility of embodiments where both an ethanol stream and a slipstream of cracked hydrocarbons are fed to a stripper unit containing a zeolite catalyst. The table shows the product profile resulting from the co-conversion of the olefin ethylene (one example of a hydrocarbon produced in an FCC riser) and ethanol over a zeolite catalyst. A first feed comprised a mixture of ethylene/H₂/N₂/H₂O (ratio of 33/36/23/8 by volume) fed with an ethylene weight hour space velocity (WHSV) of 1.0 hr⁻¹. A second feed was ethanol fed at 2 g/hr (per 5 g catalyst). The zeolite catalyst ZSM-5 was contacted with the mixture under the following conditions: 310° C., 0 psig, 1.0 hr⁻¹ (Ethylene WHSV), H₂/N₂/Ethylene/H₂O.

TABLE 2
Product Selectivity from the Co-conversion
of Ethylene and Ethanol to Hydrocarbons

| | |
|---|---|
| Ethylene Conversion (wt. %) | 86.5 |
| Ethanol Conversion (wt. %) | ~100 |
| Product Selectivity (wt. %) | |
| Methane | 0.0 |
| Ethane | 0.4 |
| Propane | 2.4 |
| Propylene | 5.3 |
| Butanes | 11.3 |
| Butenes | 11.2 |
| C5+ Products | 69.4 |
| Total (wt %) | 100.0 |

An additional advantage of the inventive systems and processes disclosed herein is to avoid the need to separate water from the ethanol stream prior to feeding this stream to the stripper unit, as this would increase costs and reduce commercial viability of the system and process.

Yet another advantage of certain embodiments is that the water present in the ethanol stream can serve as at least a portion of the steam required to strip hydrocarbons from the catalyst within the stripper unit, thereby reducing water usage.

A further potential advantage of the inventive systems and processes is that the mixed product stream (comprising hydrocarbons produced by the conversion of ethanol) moves from the stripper unit to the reactor and 1) decreases the residence time of cracked hydrocarbons as they pass from the riser through the reactor and to the fractionator, and 2) quenches these cracked hydrocarbons. Both decreasing residence time and quenching the cracked hydrocarbons serve to prevent undesirable secondary cracking reactions that may increase coke formation and decrease product quality.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims, while the description, abstract and drawings are not to be used to limit the scope of the invention. The invention is specifically intended to be as broad as the claims below and their equivalents.

We claim:

1. A system for converting ethanol to liquid transportation fuels, comprising:
a catalyst;
an ethanol stream;
a fluidized catalytic cracking unit comprising:
a riser comprising a reaction zone and adapted for mixing the catalyst with a petroleum-derived feedstock and further adapted for cracking the petroleum derived feedstock to cracked hydrocarbon vapors;
a reactor main body adapted for separating cracked hydrocarbon vapors and the catalyst;
a stripper unit that is operable at a temperature between about 260° C. and about 550° C. and comprises at least one first inlet operable to receive the catalyst, and at least one second inlet operable to receive the ethanol stream,
wherein the arrangement of the at least one first inlet and the at least one second inlet are operable to facilitate rapid mixing of the catalyst with the ethanol stream, and operable to convert the water to steam,
wherein the stripper unit is operable to facilitate mixing of the catalyst with the steam, thereby stripping hydrocarbons from the catalyst,
wherein the stripper unit is operable to receive and facilitate contact of the ethanol stream with the catalyst, thereby allowing conversion of at least a portion of the ethanol stream to a mixed product stream comprising hydrocarbons.

2. The system according to claim 1, wherein the steam is at least partly-derived from the water in the ethanol stream.

3. The system according to claim 1, wherein the arrangement of the at least one first inlet and the at least one second inlet of the stripper unit is operable to convert the water to steam prior to contacting the catalyst.

4. The system according to claim 1, further comprising a first outlet operable to discharge a mixed product stream comprising hydrocarbons and stripped catalyst to the main body of the reactor.

5. The system according to claim 1, further comprising a heater operable to heat the ethanol stream and operatively connected to convey the ethanol stream to the stripper unit, the heater adapted for heating the ethanol stream to a temperature that vaporizes the ethanol stream upon entry to the stripper unit and prevents condensation of the water in the stripper unit.

6. The system of claim 5, wherein the heater is also a mixer that is operable to receive and mix the ethanol stream with a stream of hot steam.

7. The system according to claim 1, wherein the stripper unit comprises at least two inlets operable to receive catalyst, wherein at least a first inlet is configured to receive spent catalyst and at least a second inlet is configured to receive fresh catalyst, wherein the stripper unit is configured to contact the fresh catalyst with the spent catalyst and the ethanol stream.

8. The system according to claim 1, wherein the ethanol stream is derived from biomass and comprises at least 4 weight percent of water

9. The system according to claim 1, wherein the ethanol stream is derived from biomass comprises at least 20 weight percent water.

10. The system according to claim 1, wherein the ethanol stream is derived from biomass comprises at least 40 weight percent water.

11. The system according to claim 1, wherein the stripper unit additionally comprises a third inlet for a stream of cracked hydrocarbons transported from a location proximate the upper portion of the riser, wherein the arrangement of the first, second and third inlets is operable to facilitate mixing of the catalyst, the ethanol stream and the stream of cracked hydrocarbons.

12. The system according to claim 1, wherein the stripper unit additionally comprises a third inlet that is operable to receive a stream of hydrocarbons from a fractionator located immediately downstream from the reactor of the fluidized catalytic cracking unit, wherein the arrangement of the first, second and third inlets is operable to facilitate mixing of the catalyst, the ethanol stream and the stream of cracked hydrocarbons.
